(19) United States
(12) Patent Application Publication
(10) Pub. No.: US 2024/0299881 A1
(43) Pub. Date: Sep. 12, 2024

(54) ENHANCED REPLACEMENT OF SELECTIVE CATALYTIC REDUCTION BEDS IN ETHYLENE FURNACES

(71) Applicant: Chevron Phillips Chemical Company LP, The Woodlands, TX (US)

(72) Inventors: Reed J. BASTIE, The Woodlands, TX (US); Chad J. THOMAS, The Woodlands, TX (US); Robert B. RAILEY, The Woodlands, TX (US); Casey McNAMARA, Chicago, IL (US); Colin ELLIOTT, New York, NY (US); Justin L. BROWN, The Woodlands, TX (US); Sean BEACH, The Woodlands, TX (US); Ruixuan HAN, The Woodlands, TX (US)

(73) Assignee: Chevron Phillips Chemical Company LP, The Woodlands, TX (US)

(21) Appl. No.: 18/597,726

(22) Filed: Mar. 6, 2024

Related U.S. Application Data
(60) Provisional application No. 63/450,322, filed on Mar. 6, 2023.

(51) Int. Cl. B01D 53/86

(52) U.S. Cl. CPC B01D 53/8631; B01D 53/8696; B01D 2257/404

(57) ABSTRACT

This disclosure describes systems, methods, and devices related to for estimating the end-of-life of a furnace catalyst bed. A method may include extracting first measurements of a furnace catalyst bed; determining time-period averages of the extracted first measurements of the furnace catalyst bed over multiple time periods; determining a catalyst activity indicative of an efficiency of a selective reduction catalyst in reducing NOx concentrations for the furnace catalyst bed at a first time; generating a first linear regression of the catalyst activity based on averages of the multiple time periods; and generating a health score of the furnace catalyst bed at a second time based on the first linear regression, the health score indicative of an estimated end-of-life of the furnace catalyst bed.

### CROSS-REFERENCE TO RELATED APPLICATION(S)

This application is related to and claims priority under 35 U.S.C. § 119(c) from U.S. Patent Application No. 63/450,322, filed Mar. 6, 2023, titled “ENHANCED REPLACEMENT OF SELECTIVE CATALYTIC REDUCTION BEDS IN ETHYLENE FURNACES,” the entire content of which is incorporated herein by reference for all purposes.

### TECHNICAL FIELD

Embodiments of the present disclosure generally relate to devices, systems, and methods for replacement of selective catalytic reduction beds in furnaces.

### BACKGROUND

Selective catalytic reduction (SCR) beds serve a valuable function to convert nitrous oxide (NOx) emissions from furnaces into nitrogen and water prior to being released into the atmosphere. Over time the catalyst activity of SCR beds decrease, and eventually the catalyst must be replaced. The catalyst change-out process is cumbersome, time-consuming, and expensive, and furnace down time is undesirable. Moreover, predicting when the SCR beds should be changed can be quite difficult. In some instances following furnace shut down, catalyst bed inspection reveals that the catalyst could have lasted longer. In other cases, catalysts have effective activity for a shorter time than expected and early replacement or unplanned downtime are necessary.

Therefore, improved methods for evaluating SCR beds and predicting when the beds should be changed are needed. Such methods could enhance the life of the SCR beds, reduce down time, and lower overall operating costs. The improved methods also may reduce the Title V environmental deviation reporting.

### SUMMARY

This disclosure provides for new methods for estimating the end-of-life of a furnace catalyst bed, and new devices and systems for the same. In an aspect, the new method can comprise steps that include extracting measurements of a furnace catalyst bed such as an NOx concentration or an ammonia (NH₃) feed rate, determining time-period averages of the extracted measurements over multiple time periods, determining a catalyst activity indicative of the catalyst selective reduction efficiency, and generating a linear regression of the catalyst activity based on the time-period averages in order to generate a health score of the furnace catalyst bed. This disclosure also provides a device and an overall system for estimating the end-of-life of a furnace catalyst bed.

In an aspect, the disclosure provides a method for estimating the end-of-life of a furnace catalyst bed, the method comprising: extracting measurements of a furnace catalyst bed; determining time-period averages of the extracted measurements of the furnace catalyst bed over multiple time periods; determining a catalyst activity indicative of an efficiency of a selective reduction catalyst in reducing NOx concentrations for the furnace catalyst bed at a first time; generating a first linear regression of the catalyst activity based on the time-period averages; and generating a health score of the furnace catalyst bed at a second time based on the first linear regression, the health score indicative of an estimated end-of-life of the furnace catalyst bed.

A further aspect of the disclosure provides a device for estimating the end-of-life of a furnace catalyst bed, the device comprising memory coupled to at least one processor, the at least one processor configured to: extract measurements of a furnace catalyst bed; determine time period averages of the extracted measurements of the furnace catalyst bed over multiple time periods; determine a catalyst activity indicative of an efficiency of a selective reduction catalyst in reducing NOx concentrations for the furnace catalyst bed at a first time; generate a first linear regression of the catalyst activity based on the time period averages; and generate a health score of the furnace catalyst bed at a second time based on the first linear regression, the health score indicative of an estimated end-of-life of the furnace catalyst bed.

In still another aspect of the disclosure, there is provided a system for estimating the end-of-life of a furnace catalyst bed, the system comprising: a furnace comprising a furnace catalyst bed associated with reacting NOx from the furnace and NH₃ from an ammonia vaporizer into N₂ and H₂O; and memory coupled to at least one processor, the at least one processor configured to: extract measurements of the furnace catalyst bed; determine time period averages of the extracted measurements of the furnace catalyst bed during multiple time periods; determine a catalyst activity indicative of an efficiency of a selective reduction catalyst in reducing NOx concentrations for the furnace catalyst bed at a first time; generate a first linear regression of the catalyst activity based on the time period averages; and generate a health score of the furnace catalyst bed at a second time based on the first linear regression, the health score indicative of an estimated end-of-life of the furnace catalyst bed.

These and other aspects, embodiments, and improvements are described more fully in the Disclosure Statements, the Detailed Description, the Drawings, and the Claims.

### BRIEF DESCRIPTION OF THE DRAWINGS

FIG. 1 illustrates an exemplary furnace with a catalyst bed in accordance with one embodiment.

FIG. 2 shows example graphs of a furnace catalyst bed health score in accordance with one embodiment.

FIG. 3 shows an example graph indicating the relative importance to a furnace catalyst bed health score model as a result of furnace features in accordance with one embodiment.

FIG. 4 shows an example graph of a correlation between NOx output and furnace catalyst bed health scores over time for multiple furnaces in accordance with one embodiment.

FIG. 5 shows an example graph of furnace catalyst bed health scores for multiple furnaces in accordance with one embodiment.

FIG. 6 shows an example graph of furnace catalyst bed health scores for multiple furnaces using different end-of-life thresholds in accordance with one embodiment.

FIG. 7 illustrates an example system for estimating furnace catalyst bed end-of-life in accordance with one embodiment.

FIG. 8 is a flowchart illustrating a process for estimating furnace catalyst bed end-of-life in accordance with one embodiment.

FIG. 9 is a diagram illustrating an example of a computing system that may be used in implementing embodiments of the present disclosure.

### DETAILED DESCRIPTION

Aspects of the present disclosure involve devices, systems, methods, and the like, for estimating when to replace SCR beds in ethylene furnaces.

The following disclosure Statements provide additional details of the methods, devices, and systems of this disclosure. Statements which are described as “comprising” certain components or steps, may also “consist essentially of” or “consist of” those components or steps, unless stated otherwise. Variations of these Statements will suggest themselves to those skilled in the art in light of the Detailed Description and Drawings which follows, and all such obvious variations are within the full intended scope of the appended claims.

Statement 1. A method for estimating the end-of-life of a furnace catalyst bed, the method comprising: extracting first measurements of a furnace catalyst bed; determining time-period averages of the extracted first measurements of the furnace catalyst bed over multiple time periods; determining a catalyst activity indicative of an efficiency of a selective reduction catalyst in reducing NOx concentrations for the furnace catalyst bed at a first time; generating a first linear regression of the catalyst activity based on the time-period averages; and generating a health score of the furnace catalyst bed at a second time based on the first linear regression, the health score indicative of an estimated end-of-life of the furnace catalyst bed.

Statement 1.1. The method of statement 1, wherein the time periods are about 0.1 days, 0.2 days, 0.5 days, 1 day, 2 days, 5 days, or 10 days.

Statement 1.2. The method of any preceding statement, wherein the first measurements comprise an NOx concentration upstream of the furnace catalyst bed, an NOx concentration after the furnace catalyst bed at the furnace stack, an NH₃ feed rate to the furnace catalyst bed, an NH₃ concentration after the furnace catalyst bed at the furnace stack, a furnace catalyst bed inlet temperature, a furnace catalyst bed inlet O₂ concentration, an O₂ concentration after the furnace catalyst bed at the furnace stack, a firing rate of the fuel gas burners in the furnace, a specific gravity of the fuel gas to the furnace burners, a time of operation of the furnace catalyst bed, or any combinations thereof.

Statement 2. The method of any preceding statement, wherein the first linear regression is based on a relative catalyst activity of a first-order reaction of NO, 4NO+4NH₃+O₂→4N₂+6H₂O, associated with the furnace catalyst bed and a zero-order reaction of ammonia associated with the furnace catalyst bed compared to the catalyst activity.

Statement 3. The method of any preceding statement, wherein the catalyst activity is based on a flue gas flow rate associated with the furnace catalyst bed, a total catalyst surface area, and a NOx reduction when a NH₃ concentration at an inlet of the furnace catalyst bed divided by NOx concentration at the inlet is greater than 1.

Statement 4. The method of statement 3, wherein: the change in NOx concentration after the furnace catalyst bed is determined based on one minus a ratio of NOx output over NOx input associated with the furnace catalyst bed.

Statement 5. The method of any preceding statement, further comprising: extracting second measurements of the furnace catalyst bed; determining second time period averages of the extracted second measurements of the furnace catalyst bed during a time period of multiple days; and generating a second linear regression of the catalyst activity based on the time period averages, wherein the health score is further based on the second linear regression.

Statement 6. The method of any preceding statement, further comprising: identifying an intersection between the first linear regression and a critical health score threshold, wherein the intersection is indicative of the estimated end-of-life of the furnace catalyst bed.

Statement 7. The method of any preceding statement, wherein the first linear regression is based on an equation in which ten multiplied by the natural log of a sum of one and a ratio of the catalyst activity equals ten multiplied by a difference between one and a ratio of time over the health score.

Statement 8. A device for estimating the end-of-life of a furnace catalyst bed, the device comprising memory coupled to at least one processor, the at least one processor configured to: extract first measurements of a furnace catalyst bed; determine time period averages of the extracted first measurements of the furnace catalyst bed over multiple time periods; determine a catalyst activity indicative of an efficiency of a selective reduction catalyst in reducing NOx concentrations for the furnace catalyst bed at a first time; generate a first linear regression of the catalyst activity based on the time period averages; and generate a health score of the furnace catalyst bed at a second time based on the first linear regression, the health score indicative of an estimated end-of-life of the furnace catalyst bed.

Statement 8.1. The device of statement 8, wherein the time periods are about 0.1 days, 0.2 days, 0.5 days, 1 day, 2 days, 5 days, or 10 days.

Statement 8.2. The device of any preceding statement, wherein the first measurements comprise an NOx concentration upstream of the furnace catalyst bed, an NOx concentration after the furnace catalyst bed at the furnace stack, an NH₃ feed rate to the furnace catalyst bed, an NH₃ concentration after the furnace catalyst bed at the furnace stack, a furnace catalyst bed temperature, a furnace catalyst bed inlet temperature, a furnace catalyst bed inlet O₂ concentration, an O₂ concentration after the furnace catalyst bed at the furnace stack, a firing rate of the fuel gas burners in the furnace, a specific gravity of the fuel gas to the furnace burners, a time of operation of the furnace catalyst bed, or any combinations thereof.

Statement 9. The device of any of statements 8-8.2, wherein the first linear regression is based on a relative catalyst activity of a first-order reaction of NO, 4NO+4NH₃+O₂→4N₂+6H₂O, associated with the furnace catalyst bed and a zero-order reaction of ammonia associated with the furnace catalyst bed compared to the catalyst activity.

Statement 10. The device of any of statements 8-9, wherein the catalyst activity is based on a flue gas flow rate associated with the furnace catalyst bed, a total catalyst surface area, and a NOx reduction when a NH₃ concentration at an inlet the furnace catalyst bed divided by a change in a NOx concentration at the inlet is greater than 1.

Statement 11. The device of any of statements 8-10, wherein: the change in NOx concentration after the furnace catalyst bed based on one minus a ratio of NOx output over NOx input associated with the furnace catalyst bed.

Statement 12. The device of any of statements 8-11, wherein the at least one processor is further configured to: extract second measurements of the furnace catalyst bed; determine second time period averages of the extracted second measurements of the furnace catalyst bed during a time period of multiple days; and generate a second linear regression of the catalyst activity based on the second time period averages, wherein the health score is further based on the second linear regression.

Statement 13. The device of any of statements 8-12, wherein the at least one processor is further configured to: identify an intersection between the first linear regression and a critical health score threshold, wherein the intersection is indicative of the estimated end-of-life of the furnace catalyst bed.

Statement 14. The device of any of statements 8-13, wherein the first linear regression is based on an equation in which ten multiplied by the natural log of a sum of one and a ratio of the catalyst activity equals ten multiplied by a difference between one and a ratio of time over the health score.

Statement 15. A system for estimating the end-of-life of a furnace catalyst bed, the system comprising: a furnace comprising a furnace catalyst bed associated with reacting NOx from the furnace and NH₃ from an ammonia vaporizer into N₂ and H₂O; and memory coupled to at least one processor, the at least one processor configured to: extract first measurements of the furnace catalyst bed; determine time period averages of the extracted first measurements of the furnace catalyst bed during multiple time periods; determine a catalyst activity indicative of an efficiency of a selective reduction catalyst in reducing NOx concentrations for the furnace catalyst bed at a first time; generate a first linear regression of the catalyst activity based on the time period averages; and generate a health score of the furnace catalyst bed at a second time based on the first linear regression, the health score indicative of an estimated end-of-life of the furnace catalyst bed.

Statement 15.1. The system of statement 15, wherein the time periods are about 0.1 days, 0.2 days, 0.5 days, 1 day, 2 days, 5 days, or 10 days.

Statement 15.2. The system of statement 15 or 15.1, wherein the first measurements comprise an NOx concentration within a furnace, an NOx concentration upstream of the furnace catalyst bed, an NOx concentration after the furnace catalyst bed at the furnace stack, an NH₃ feed rate to the furnace catalyst bed, an NH₃ concentration after the furnace catalyst bed at the furnace stack, a furnace catalyst bed temperature, a furnace catalyst bed inlet temperature, a furnace catalyst bed inlet O₂ concentration, an O₂ concentration after the furnace catalyst bed at the furnace stack, a firing rate of the fuel gas burners in the furnace, a specific gravity of the fuel gas to the furnace burners, a time of operation of the furnace catalyst bed, or any combinations thereof.

Statement 16. The system of any of statements 15-15.2, wherein the first linear regression is based on a relative catalyst activity of a first-order reaction of NO, 4NO+4NH₃+O₂→4N₂+6H₂O, associated with the furnace catalyst bed and a zero-order reaction of ammonia associated with the furnace catalyst bed compared to the catalyst activity.

Statement 17. The system of any of statements 15-16, wherein the catalyst activity is based on a flue gas flow rate associated with the furnace catalyst bed, a total catalyst surface area, and a NOx reduction when a NH₃ concentration at an inlet the furnace catalyst bed divided by a change in a NOx concentration at the inlet is greater than 1.

Statement 18. The system of any of statements 15-17, wherein: the change in NOx concentration after the furnace catalyst bed based on one minus a ratio of NOx output over NOx input associated with the furnace catalyst bed.

Statement 19. The system of any of statements 15-18, wherein the at least one processor is further configured to: extract second measurements of the furnace catalyst bed; determine second time period averages of the extracted second measurements of the furnace catalyst bed during a time period of multiple days; and generate a second linear regression of the catalyst activity based on the second time period averages, wherein the health score is further based on the second linear regression.

Statement 20. The system of any of statements 15-19, wherein the at least one processor is further configured to: identify an intersection between the first linear regression and a critical health score threshold, wherein the intersection is indicative of the estimated end-of-life of the furnace catalyst bed.

Statement 21. The system of any of statements 15-20, wherein the first linear regression is based on an equation in which ten multiplied by the natural log of a sum of one and a ratio of the catalyst activity equals ten multiplied by a difference between one and a ratio of time over the health score.

In this disclosure, the following abbreviations and definitions are utilized. BFW: Boiler feedwater (the water fed into a steam drum from a feed pump, where the steam drum converts the boiler feedwater to steam). FG: Fuel gas. #1 liquid feed: a first supply feed pipeline to delivery liquid (e.g., butanes and heavier hydrocarbons) to the furnace for cracking. #2 liquid feed: a second supply feed pipeline to delivery liquid (e.g., butanes and heavier hydrocarbons) to the furnace for cracking. The #1 and #2 liquid feeds may be referred to as “liquid feeds” heavier than other gas feeds such as ethane, ethane/propane mix, and propane. BTU: British thermal unit. Lb: pound (unit weight measure). MMBTU: One million BTUs. K: Catalyst activity.

SCR beds are installed on ethylene furnaces to help control NOx emissions (e.g., from an ethylene cracking process). Controlling NOx emissions is a key environmental consideration. Additionally, feed and firing rates can cause high SCR bed temperatures that force the unit to throttle production rates accordingly. SCR beds must be changed out on a regular basis (e.g., about every three years) once the bed is at end-of-life. This replacement requires the respective furnace to be down, thus reducing the annual on-stream factor and overall unit production. Predicting SCR bed change-out is generally manual with ongoing engineer oversight, and feed/firing rates for optimal SCR bed operation at any point in time are not well-defined.

Pyrolysis or steam cracking is a thermal conversion process used to manufacture intermediate olefin products (ethylene and propylene) from light hydrocarbon feedstocks (ethane, propane, and liquid feed streams). This thermal cracking process converts the feed to lower molecular weight hydrocarbons at high temperature and low pressure. The cracking reactions take place in the furnace coils to which the dilution steam is added. A byproduct of the cracking process is the creation of NOx within the furnace. SCR beds are installed within the furnace to reduce NOx emissions. The process requires multiple components including an Air Blower, Ammonia Vaporizer, and an SCR beds as explained below.

Filtered air is sucked in by air blowers and is preheated as it flows through the dilution air coils in the furnace convection section. The hot air then flows to the ammonia vaporizers where it comes in contact with, heats, and vaporizes the aqueous ammonia. The combined flow of vaporized ammonia and hot air is then equally distributed into the convection section flue gas directly below the SCR beds. Vaporized ammonia flows (rises) with the flue gas through the SCR bed catalyst constituting the reduction of the nitrogen oxides. At temperatures between about 400° F. and about 800° F., the nitrogen oxides are reacted with ammonia on the surface of the SCR bed catalyst to form nitrogen and water. If the temperature is too low, the reaction does not occur. If the temperature is too high, the catalyst can be damaged. The reactions are exothermic which causes a slight temperature increase of the flue gas after passing through the catalyst. The SCR beds are located between the upper BFW (boiler feedwater) preheat and the lower BFW preheat coils in the furnace, for example.

Catalyst deactivation occurs over time for various reasons which reduces the SCR bed's ability to remove NOx from the flue gas.

The first and primary method for catalyst deactivation is poisoning. Certain fuel constituents that are released during combustion act as catalyst poisons. The hot flue gas can also strip metallic elements from the cracking coils in the furnace and deposit these poisons on the SCR bed. Catalyst poisons include chromium, calcium oxide, magnesium oxide, potassium, sodium, arsenic, chlorine, fluorine, and lead. These constituents deactivate the catalyst by diffusing into active pore sites and occupying them.

The next method of catalyst deactivation is thermal sintering. High flue gas temperatures within the SCR reactor cause sintering, a permanent loss of catalyst activity due to a change in the pore structure of the catalyst. Thermal sintering can occur at temperatures as low as 450° F. Newer catalyst materials are less susceptible to thermal sintering.

Lastly, catalyst deactivation can be caused by fouling. Ammonia-sulfur salts, fly ash, and other particulate matter in the flue gas cause binding, plugging, or fouling of the catalyst. The particulate matter deposits on the surface and in the active pore sites of the catalyst. This results in a decrease of the number of sites available for NOx reduction and an increase in flue gas pressure loss across the catalyst.

Furnaces may include a SCR bed, ammonia vaporizer, and air blower. A SCR bed may have its own ammonia vaporizer and air blower, for example. SCR beds create a surface for reacting NOx from the furnace and NH₃ from the ammonia vaporizer into N₂ and H₂O. Ammonia vaporizers mix aqueous ammonia with hot air, vaporize the vapor, and pump the vapor directly below the SCR beds. The hot air and ammonia vapor mixture rises and is equally distributed across the SCR bed for reaction. The air blowers may suck in filtered air at ambient temperature, and the air may be heated as it is pumped across dilution air coils in the furnace and added to the ammonia vaporizer to vaporize the aqueous ammonia.

A core problem solved by the enhancements herein include the SCR bed getting too hot, a temperature limit leading to backed out conversion, and increased cracked prop.

In one or more embodiments, the conversion curve of the SCR beds (e.g., to determine when to replace an SCR bed) may be modeled over time, leveraging historical process data. The model may predict the likelihood of reaching annual NOx limits (e.g., measured by lb NOx/MMBTU) by forecasting causal variables (e.g., NOx/BTU/hour, temperatures, ammonia flow, etc.) in advance of the SCR bed end-of-life. There may be operating regimes (e.g., BTUs, feed type, etc.) that degrade SCR bed health faster, and therefore there may be better ways of operating furnaces to help extend the life of an SCR bed. These hypotheses may be used for the enhancements presented herein, which may extend the life of a SCR bed by predicting the likelihood of a SCR bed hitting its annual NOx limit in advance and identifying operating efficiencies to extend the SCR bed life.

In one or more embodiments, a health score (e.g., 0-10) may be used to predict when a SCR bed is to be changed. The health score may be defined by Equation (1):

$$Health Score = 10 * \frac{K}{{K}_{0}} , \qquad ( 1 )$$

where the catalyst activity K represents the efficiency of the SCR catalyst in reducing NOx concentration, and the relative catalyst K/K₀ compared to the new catalyst may evaluate the health status of the SCR bed. The catalyst activity K may be defined using a first-order reaction in terms of NO, and zero order in terms of ammonia.

In one or more embodiments, the equation for the SCR catalyst activity may be according to Equation (2):

$$K = \frac{- {Q}_{fg}}{A * ln ( 1 - Δ NOx )} , \qquad ( 2 )$$

where Q_{fg} is the flue gas flow rate expressed at standard conditions, i.e., about 0 degrees Celsius (about 68 degrees Fahrenheit) and about 1 atm, A is the total catalyst surface area, and ΔNOx is the NOx reduction when the

$$\frac{{NH}_{3}}{NOx} > 1.$$

In one or more embodiments, the catalyst activity K may depend on the operating time according to Equation (3):

$$K = {K}_{0} {e}^{( \frac{- t}{τ} )} , \qquad ( 3 )$$

where t is the operating time (e.g., hours that the SCR bed has been in use), K₀ is the original catalyst activity, and t is the catalyst operating lifetime constant. K may be the rate constant of the first-order reaction of NO: 4NO+4NH₃+O₂→4N₂+6H₂O; this is the formula used to generate the catalyst activity equation in the model. The t may be extracted based on

$$ln ( K ) = - \frac{t}{τ} + ln ( {K}_{0} ) ,$$

and the health score may be represented by

$$10 {e}^{( \frac{- t}{τ} )} .$$

For example, when τ=37091, the health score may be 2.8. Using a critical threshold of 3.7 for the health score, when the SCR bed's health score reaches the critical threshold may be predicted based on the linear curve. In another example, when

$$τ = 52669 \frac{hours}{6.} years ,$$

the health score may be 4.0 with an estimated 6.8 months remaining.

In one or more embodiments, calculating the health score of a SCR bed may use Equation (4):

$$KA = - {Q}_{fg} * ln ( 1 - Δ NOx ) ( \frac{{NH}_{3}}{NOx} > 1 ) , \qquad ( 4 )$$

where A is a constant for a type of SCR bed. The NOx emission rate may be calculated using Equation (5):

$$NOx Corrected to 0 \% {O}_{2} = NOx in PPM * ( \frac{( 20.9 - 0. )}{( 20.9 - {O}_{2} in \% )} . \qquad ( 5 )$$

The NOx (lb/MMBTU) may be represented by NOx Corrected to 0% O₂*0.0000001194*Fuel Factor, where Fuel Factor=Fuel_{H2}*5970+Fuel_{CH4}*8710, where

$${Fuel}_{H 2} = \frac{( 0.5539 - {Fuel}_{SC} )}{( 0.5539 - 0.0696 )} ,$$

and Fuel_{CH4}=(1−Fuel_{H2}). NOx (lb/hr) may be represented by

$${NO}_{x} ( \frac{lb}{MMBTU} ) * FG Duty ( \frac{MMBTU}{hr} ) .$$

The ΔNOx calculation may be ΔNOx=1−NOX_{OUT}/NOX_IN. Data used for the health score may include sample time, down/up, NOx before SCR, NOx at stack, O₂ at stack, O₂ SCR inlet, FG (fuel gas) BTU control, FG specific gravity, ammonia flow, west SCR inlet temperature, center SCR inlet temperature, and east SCR inlet temperature (e.g., for multiple SCR inlets). In one or more embodiments, the data may be extracted from the furnaces, scrubbed, used to generate features, and used for the regression to estimate the remaining life of the SCR bed (e.g., according to Equation (6) below). For example, every day a daily average of the data may be determined. A linear regression model may be used to generate the coefficients for the SCR bed health score.

In one or more embodiments, the linear regression model may be trained using features such as flue to stack temperature, flue arch average temperature, molarity of NH₃/NOx, furnace feed type, coil out average temperature, NH₃ to SCR temperature, SCR inlet, NOx before SCR lb/hr, SCR inlet temperature, and days online (for the furnace). The target variables may include NOx at the stack, the NOx before SCR, O₂ at the stack, O₂ before SCR, BTU control, and specific gravity. Independent variables may include SCR bed operational hours, SCR inlet average temperature (e.g., three temperatures mean), injected NH₃ flow, production days online, and feed type (e.g., liquid feed 1, liquid feed 2, ethane, propane, ethane/propane mixture, etc.).

In one or more embodiments, the enhanced health score may be determined according to Equation (6):

$$Health Score = 10 [ ln ( \frac{K}{{K}_{0}} ) + 1 ] = 10 ( 1 - \frac{t}{τ} ) ,$$

so the remaining months of SCR bed life may be calculated as

$$τ * \frac{Health Score}{10} .$$

In this manner, the enhanced health score of Equation (6) may move the health score from an exponential equation (e.g., Equation (1)) to a linear equation. The SCR threshold may be simplified (e.g., from 3.7 to 0), and the linear equation may provide a better sense of estimated SCR bed life remaining.

The K/K₀ relative activity values need to be compared under the same operating conditions, however, the operating time may differ from the initial time, sometimes as much as by several years. Therefore, K₀ should be corrected according to the operating conditions of K. However, the influence of T, NH₃ flow, and other operating conditions on K may be unclear due to the complexity of the reaction. Therefore, a linear regression machine learning model according to

$$ln K = - \frac{t}{τ} + ln {K}_{0} ( T , {NH}_{3} flow , … )$$

may be used to extract the pattern and determine the coefficients of the SCR bed operation hours. Then, the lifespan t may be calculated based on

$$Health Score = 10 - [ ln ( \frac{K}{{K}_{0}} ) + 1 ] = 10 ( 1 - \frac{t}{τ} )$$

and SCR Bed Life Remaining=τ−t. The target variables may be represented by ln(KA)=ln[Q_{fg} ln((1−ΔNOx))], with NOx at the stack, NOx before SCR, O₂ at the stack, O₂ before SCR, BTU Control, and specific gravity as variables. Independent variables may include SCR bed operational hours, SCR inlet average temperature (e.g., three temperatures mean), injected NH₃ flow, production days online, and feed type (e.g., liquid feed 1, liquid feed 2, ethane, propane, etc.).

After cleaning, the linear regression model may be represented by

$$ln K = - \frac{t}{τ} + ln {K}_{0} ( T , {NH}_{3} flow , … ) + {a}_{c} {L}_{cleaned} ,$$

where the lifetime may be extended by cleaning according to a_{c}·τ, the life remaining cleaned may be equal to τ−t+a_{c}·τ, and the health score after cleaning may be represented by

$$10 ( 1 - \frac{t}{τ} + {a}_{c} ) .$$

In actual operations, some SCR beds are cleaned to extend their service life. When this happens, a cleaning feature should be added to the machine learning model, and the SCR bed data should be labeled after cleaning as 1 and before cleaning as 0. The coefficient of the cleaning feature (a_{c}) is obtained through training the model and reflects the increased relative catalyst activity due to cleaning. Multiplying this coefficient by the lifespan (τ) gives the extended lifetime of SCR bed due to cleaning as shown above. Adding this time to the remaining time calculated by the model gives the updated remaining life of the SCR bed after cleaning equation as shown above. The health score of the SCR bed after cleaning can be obtained by dividing the updated remaining life by the lifespan (τ), as shown above.

In one or more embodiments, based on the SCR bed health score, recommendations may be presented to a furnace user to extend the SCR bed life and/or to replace an SCR bed. For example, recommendations may include one or more of adjusting furnace operation to reduce NOx emissions (e.g., reducing gas flow), increasing/decreasing NOx at stack control target, control NH₃/NOx directly, improve NH₃ injection flow control, cleaning the SCR bed, and the like.

The above descriptions are for purposes of illustration and are not meant to be limiting. Numerous other examples, configurations, processes, etc., may exist, some of which are described in greater detail below. Example embodiments will now be described with reference to the accompanying figures.

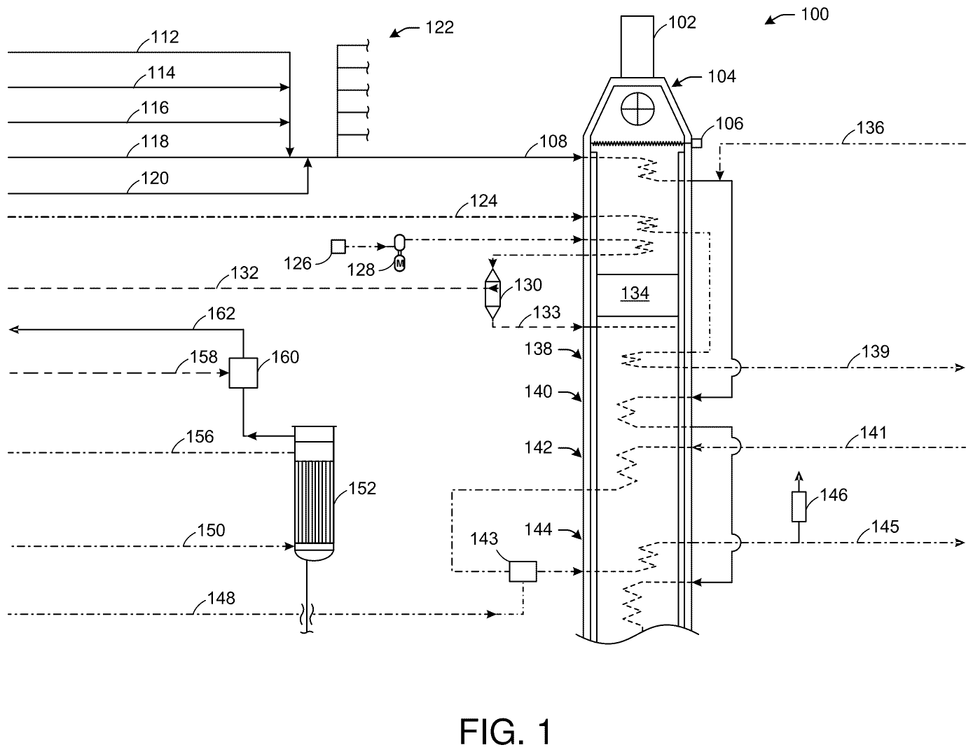

FIG. 1 illustrates an exemplary furnace 100 with a catalyst bed in accordance with one embodiment.

Referring to FIG. 1, the furnace 100 may include a stack 102, induced draft fans 104, a damper 106, and may receive a feed preheat 110 (e.g., for boiler feed water), including an E/P feed 112, a propane feed 114, a first liquid feed 116, a second liquid feed 118, and/or an ethane feed 120 through inlet coils 122. The furnace 100 may include an upper preheat 124, a filter 126, an air blower 128, an ammonia vaporizer 130 to receive aqueous ammonia 132 and generate an ammonia vapor 133. The furnace 100 may include an SCR bed 134, and may receive dilution steam 136. The furnace 100 may include a lower preheat 138 (e.g., which may produce a preheated boiler feed water 139), an upper mixed preheat 140, and may receive steam 141 for an upper steam superheat 142. The furnace 100 may include a steam de-superheater 143 for a lower steam superheat 144 that may provide steam 145 (some of which may pass to a silencer 146). The steam de-superheater 143 may receive chemical-free boiler feed water 148.

Still referring to FIG. 1, boiler feed water 150 may be received by a transfer line exchanger 152, which may provide steam 156. Quench oil 158 may be provided to a quench fitting 160, which may provide furnace effluent 162.

In one or more embodiments, the SCR bed 134 may control NOx emissions (e.g., from an ethylene cracking process). Controlling NOx emissions is a key environmental consideration. The SCR bed 134 may create a surface for reacting NOx from the furnace 100 and NH₃ from the ammonia vaporizer into N₂ and H₂O. The ammonia vaporizer 130 may mix the aqueous ammonia 132 with hot air, vaporize the vapor 133, and pump the vapor 133 directly below the SCR bed 134. The hot air and ammonia vapor 133 mixture rises and is equally distributed across the SCR bed 134 for reaction. The air blower 128 may suck in filtered air at ambient temperature, and the air may be heated in the furnace 100 and added to the ammonia vaporizer 130 to vaporize the aqueous ammonia 132.

In one or more embodiments, a health score (e.g., 0-10) may be used to predict when the SCR bed 134 is to be changed. Equation (6) above may be used to determine when the SCR bed 134 needs to be changed. In this manner, the enhanced health score of Equation (6) may move the health score from an exponential equation (e.g., Equation (1)) to a linear equation. The SCR threshold may be simplified (e.g., from 3.7 to 0), and the linear equation may provide a better sense of estimated SCR bed life remaining.

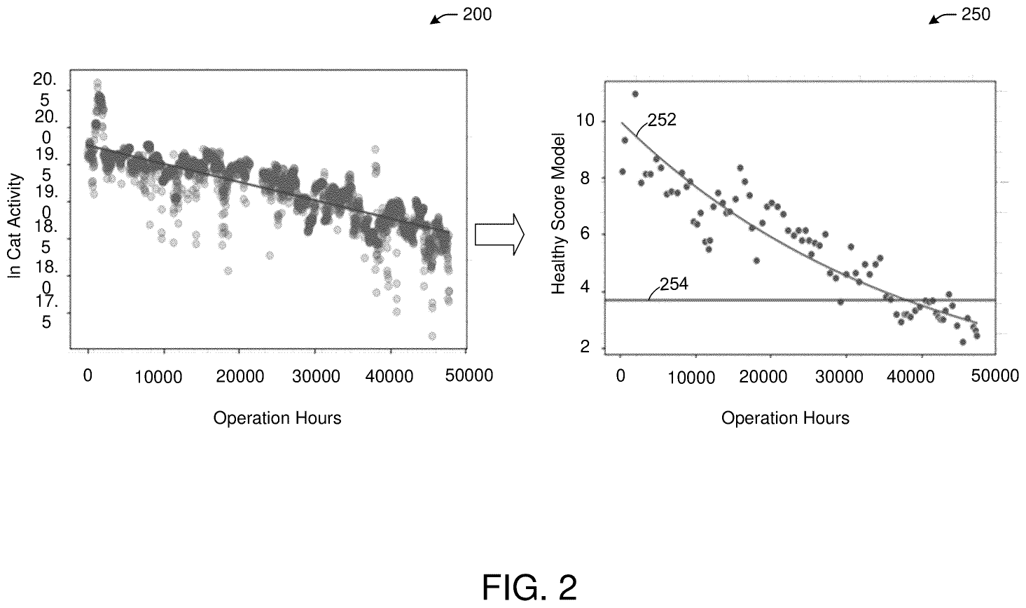

FIG. 2 shows example graphs of a furnace catalyst bed health score in accordance with one embodiment.

Referring to FIG. 2, a graph 200 shows the natural log (In) of catalyst activity in a furnace (e.g., the SCR bed 134 of the furnace 100 of FIG. 1) over operational hours. Using the graph 200, the t value (e.g., Equation (3)) may be extracted based on

$$ln ( K ) = - \frac{t}{τ} + ln ( {K}_{0} ) .$$

Still referring to FIG. 2, a graph 250 shows a SCR health score 252 according to

$$10 {e}^{( \frac{- t}{τ} )} .$$

For example, when τ=37091, the health score 252 may be 2.8. Using a critical threshold 254 of 3.7 for the health score 252, when the SCR bed's health score 252 reaches the critical threshold 254 may be predicted based on the linear curve. In another example, when

$$τ = 52669 \frac{hours}{6.} years ,$$

the health score 252 may be 4.0 with an estimated 6.8 months remaining.

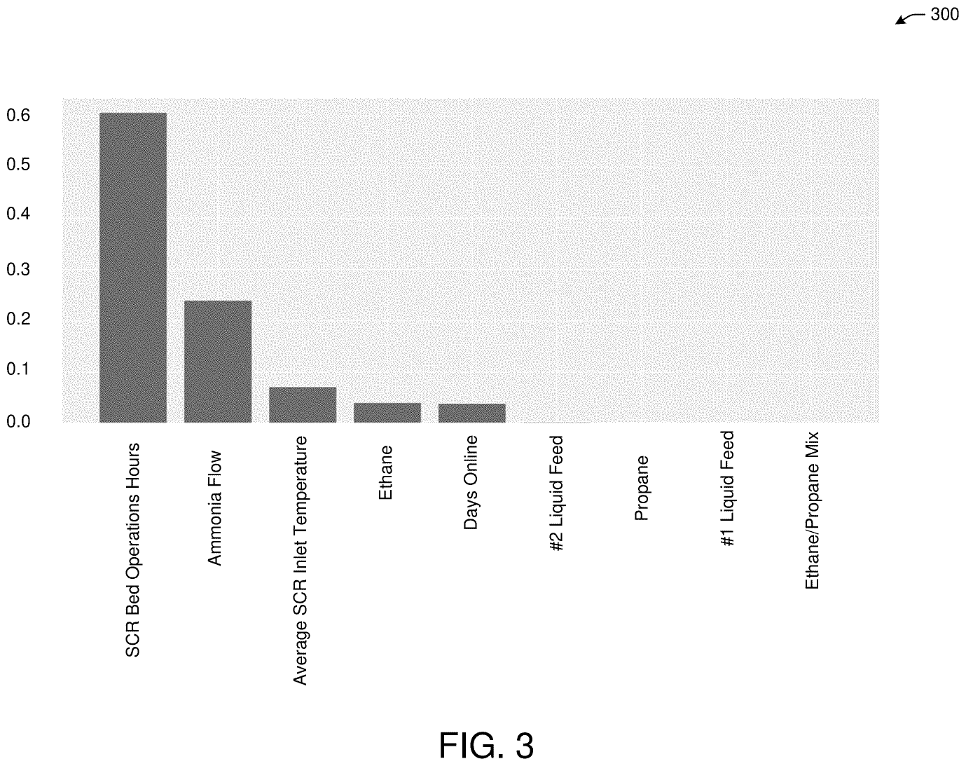

FIG. 3 shows an example graph indicating the relative importance to a furnace catalyst bed health score model as a result of furnace features in accordance with one embodiment.

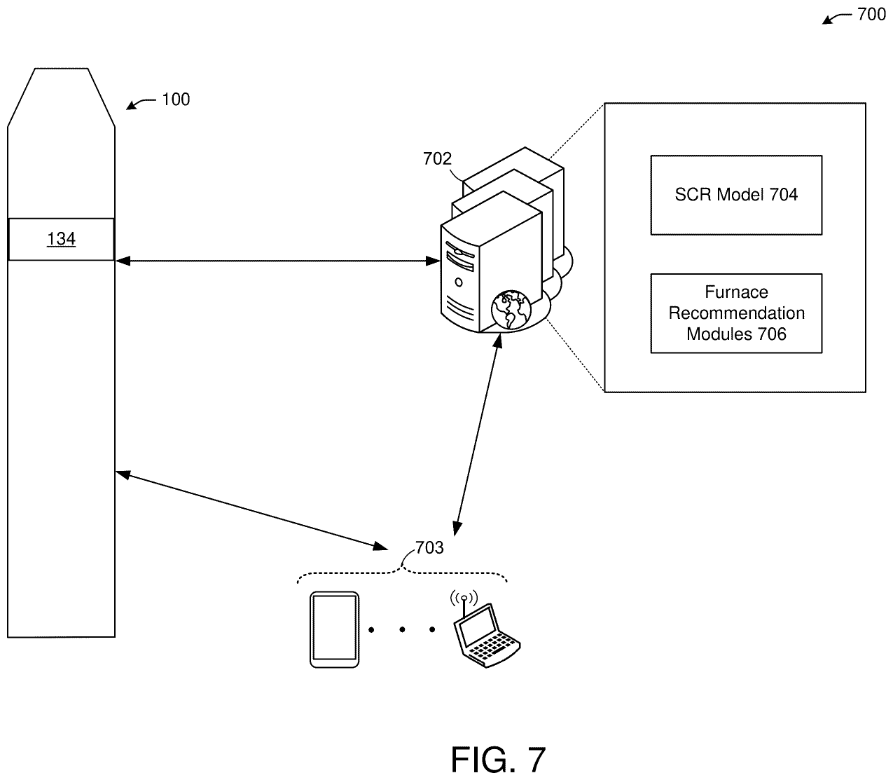

Referring to FIG. 3, the graph 300 shows an initial modeling result for data of the furnace 100 of FIG. 1, for example. The Y-axis may be feature importance, and the X-axis may be selected features such as #2 liquid feed (e.g., the second liquid feed 118 of FIG. 1 NH₃ flow, average SCR inlet temperature, days online, ethane (e.g., the ethane feed 120 of FIG. 1), #1 liquid feed (e.g., the first liquid feed 116 of FIG. 1), propane, ethane/propane mixture, SCR bed operation hours, and ammonia flow. The modeling data used may be 80% training data and 20% validation data (e.g., received from the furnace 100). The model (e.g., as shown in FIG. 7) may use a Random Forest Regressor, for example.

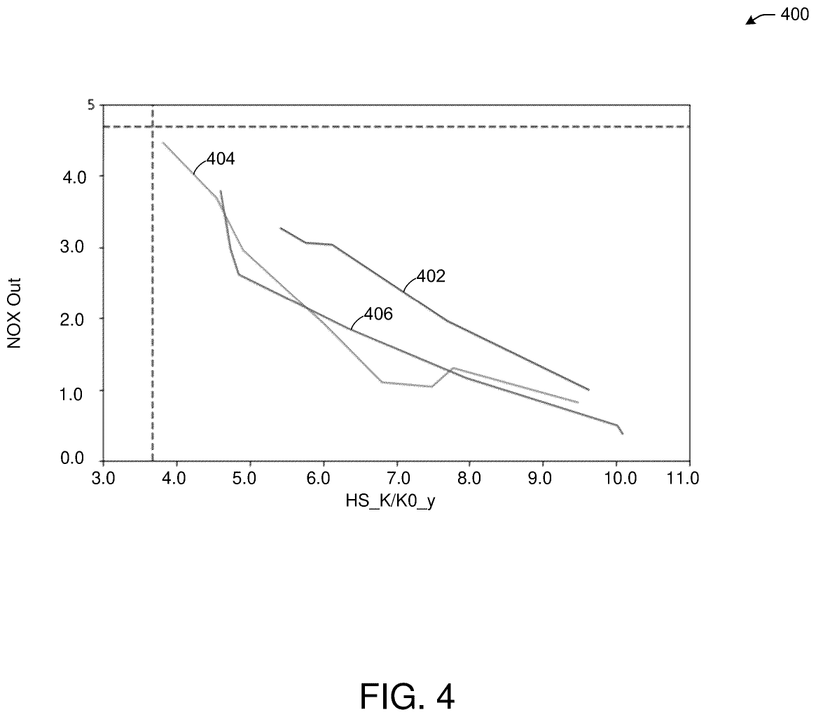

FIG. 4 shows an example graph 400 of a correlation between NOx output and furnace catalyst bed health scores over time for multiple furnaces in accordance with one embodiment.

Referring to FIG. 4, the graph 400 shows, for furnace 402, furnace 404, and furnace 406 (e.g., different furnace models with SCR beds), the correlation between NOx output and the SCR bed health score. As shown, a higher health score for the SCR bed generally correlates to a lower NOx output for an SCR bed of a furnace. The health score may use:

$$\frac{10 * K}{{K}_{0}} for \frac{NH 3}{NO} > 1 ,$$

where K is a rate constant for the first-order reaction of NO: 4NO+4NH₃+O₂→4N₂+6H₂O.

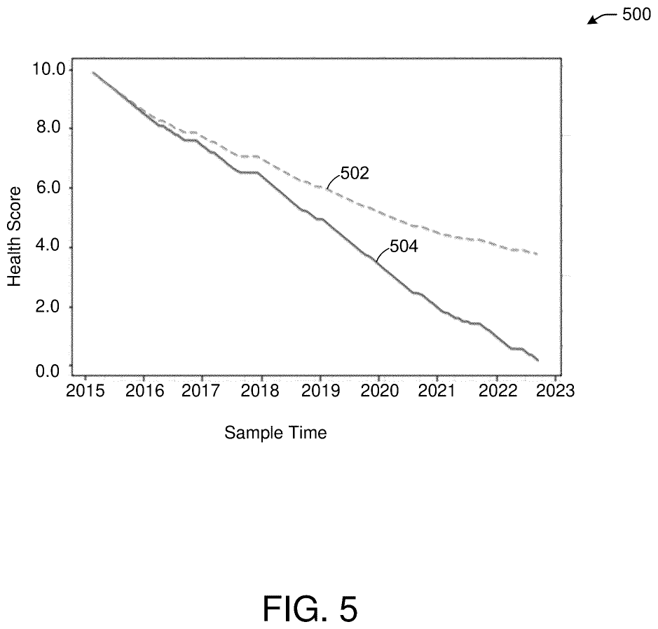

FIG. 5 shows an example graph 500 of furnace catalyst bed health scores for multiple furnaces in accordance with one embodiment.

Referring to FIG. 5, the graph 500 shows SCR bed health score 502 using

$$\frac{10 * K}{{K}_{0}} = 10 {e}^{( \frac{- t}{τ} )}$$

and SCR bed health score 504 using

$$10 [ ln ( \frac{K}{{K}_{0}} ) + 1 ] = 10 ( 1 - \frac{t}{τ} ) .$$

As shown, the modified scoring calculation herein moves from exponential to linear and simplifies the end-of-life threshold (e.g., to zero) to provide a better sense of estimated SCR bed life remaining (e.g.,

$$( e . g . , remaining months = \frac{τ * Health Score}{10} ) .$$

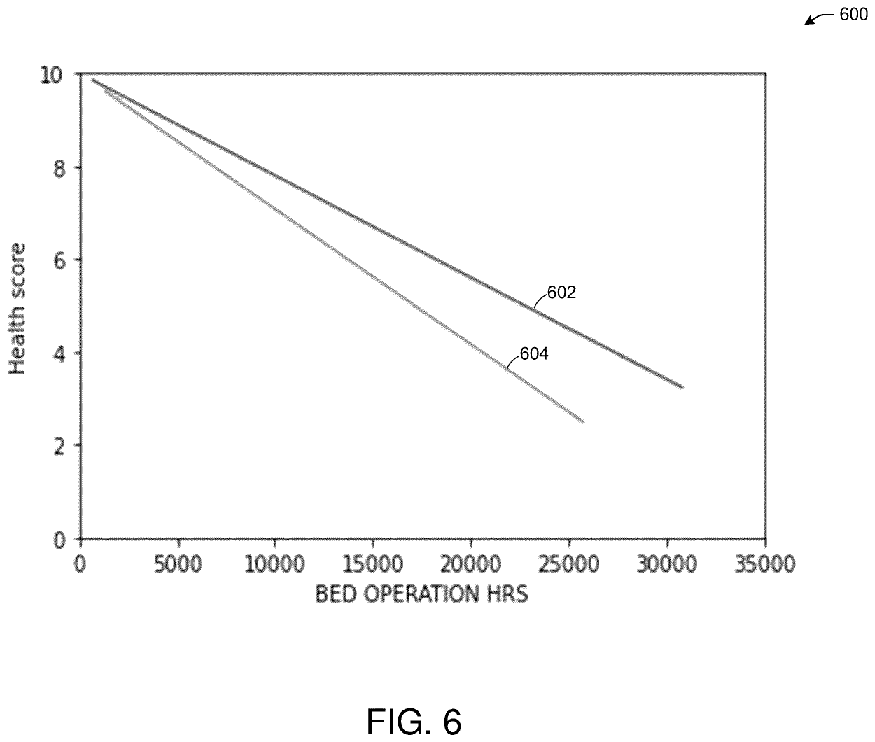

FIG. 6 shows an example graph 600 of furnace catalyst bed health scores for multiple furnaces using different end-of-life thresholds in accordance with one embodiment.

Referring to FIG. 6, the graph 600 shows the health score of the furnace 100 of FIG. 1 using a first SCR bed 602 and using a second SCR bed 604. As shown, the second SCR bed 604 deteriorates faster than the first SCR bed 602 (e.g., the second SCR bed 604 was replaced after 4.3 years at a health score of 2.5). A main reason for the faster deterioration is a smaller NH₃/NOx ratio. In addition, the first SCR bed 602 may have a smaller slip factor than the second SCR bed 604, and therefore a longer lifespan.

FIG. 7 illustrates an example system 700 for estimating furnace catalyst bed end-of-life in accordance with one embodiment.

Referring to FIG. 7, the furnace 100 may communicate with a remote system 702 and/or user devices 704 (e.g., smartphones, laptops, computers, smart home devices, etc.) to determine the estimated end-of-life of the SCR bed 134 of FIG. 1. The remote system 702 may include a SCR model 704 for determining the health score and associated end-of-life estimate for the SCR bed 134. Based on the health score, furnace recommendation modules 706 may generate and provide recommendations for SCR bed 134 replacement and/or furnace 100 operations. The remote system 702 may send the recommendations to the furnace 100 and/or to the user devices 703 for presentation.

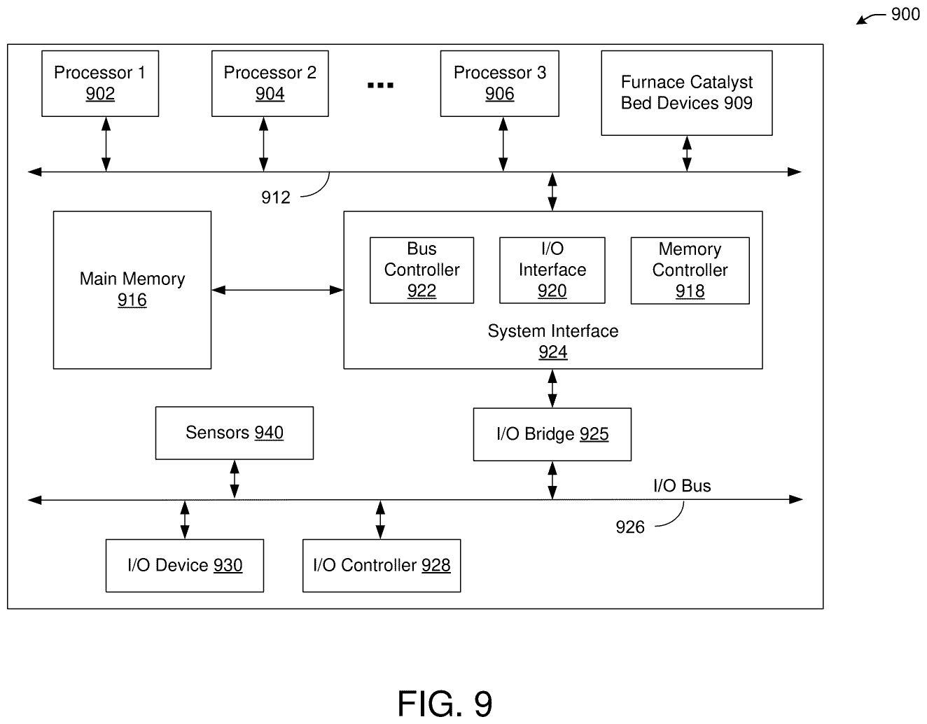

In one or more embodiments, the SCR model 704 may use the linear model described above to determine the SCR bed 134 health score and estimate its end-of-life. The furnace 100 may include sensors (e.g., the sensors 940 of FIG. 9) to detect data to send to the remote system 702 for analysis. The data may include, for example, sample time, down/up, NOx before SCR, NOx at stack, O₂ at stack, O₂ SCR inlet, FG BTU control, FG specific gravity, ammonia flow, west SCR Inlet temperature, center SCR inlet temperature, and east SCR inlet temperature. In one or more embodiments, the data may be extracted from the furnace 100, scrubbed, used to generate features, and used for the regression to estimate the remaining life of the SCR bed (e.g., according to Equation (6) above). For example, every day a daily average of the data may be determined. A regression may be used to generate the coefficients for the SCR bed 134 health score.

In one or more embodiments, the SCR model 704 may be trained using features such as flue to stack temperature, flue arch average temperature, molarity of NH₃/NOx, furnace feed type, coil out temperature average, NH₃ to SCR temperature, SCR inlet, NOx before SCR lb/hr, SCR inlet temperature, days online (for the furnace).

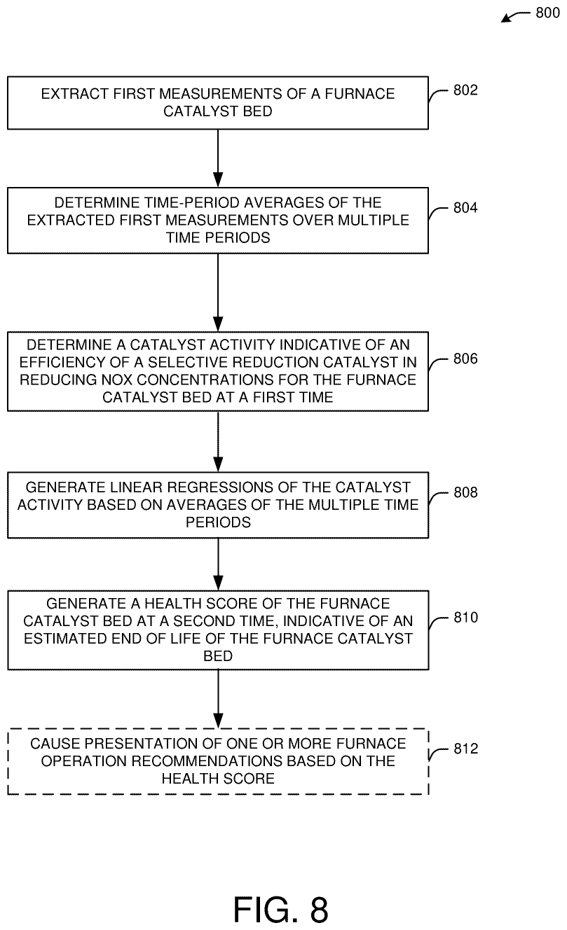

FIG. 8 is a flowchart illustrating a process 800 for estimating furnace catalyst bed end-of-life in accordance with one embodiment.

At block 802, a device (or system, e.g., the furnace 100 of FIG. 1, the remote system 702 of FIG. 7, the furnace catalyst bed devices 909 of FIG. 9) may extract first measurements of a furnace catalyst bed (e.g., the SCR bed 134 of FIG. 1). The first measurements may include, but are not limited to, a NOx concentration upstream of the furnace catalyst bed, a NOx concentration after the furnace catalyst bed at the furnace stack, an NH₃ feed rate to the furnace catalyst bed, an NH₃ concentration after the furnace catalyst bed at the furnace stack, a furnace catalyst bed temperature, a furnace catalyst bed inlet temperature, a furnace catalyst bed inlet O₂ concentration, an O₂ concentration after the furnace catalyst bed at the furnace stack, a firing rate of the fuel gas burners in the furnace, a specific gravity of the fuel gas to the furnace burners, a time of operation of the furnace catalyst bed, or any combinations thereof.

At block 804, the device may determine time-period averages of the first measurements over multiple time periods. For example, the device may determine time-period averages of the different types of data of the first measurements.

At block 806, the device may determine a catalyst activity indicative of an efficiency of a selective reduction catalyst in reducing NOx concentrations for the furnace catalyst bed at a first time. The catalyst activity K may be defined using a first-order reaction in terms of NO: 4NO+4NH₃+O₂→4N₂+6H₂O.

At block 808, the device may generate linear regressions of the catalyst activity. At block 810, the device may generate a health score of the furnace catalyst bed at a second time, the health score indicative of an estimated end-of-life of the furnace catalyst bed (e.g., using Equation (6) above, linearize the health score calculation using the regression).

At 812, optionally, based on the health score, the device may cause presentation (e.g., generate, send, and/or present presentation data) of furnace recommendations, such as when to replace the furnace catalyst bed, and/or how to operate the furnace to extend the life of the furnace catalyst bed.

It is understood that the above descriptions are for purposes of illustration and are not meant to be limiting.

FIG. 9 is a block diagram illustrating an example of a computing device or computer system 900, which may be used in implementing the embodiments of the components of the network disclosed above. For example, the computing system 900 of FIG. 9 may represent at least a portion of the furnace 100 of FIG. 1, the remote system 702 of FIG. 7, and/or the user devices 703 of FIG. 7, as discussed above. The computer system (“system”) includes one or more processors 902-906 and one or more furnace catalyst bed devices 909 (e.g., representing at least a portion of the furnace 100 of FIG. 1, the remote system 702 of FIG. 7, and/or the user devices 703 of FIG. 7, capable of performing any operations described with respect to FIG. 8). Processors 902-906 may include one or more internal levels of cache (not shown) and a bus controller 922 or bus interface unit to direct interaction with the processor bus 912. Processor bus 912, also known as the host bus or the front side bus, may be used to couple the processors 902-906 with the system interface 924. System interface 924 may be connected to the processor bus 912 to interface other components of the system 900 with the processor bus 912. For example, system interface 924 may include a memory controller 918 for interfacing a main memory 916 with the processor bus 912. The main memory 916 typically includes one or more memory cards and a control circuit (not shown). System interface 924 may also include an input/output (I/O) interface 920 to interface one or more I/O bridges 925 or I/O devices with the processor bus 912. One or more I/O controllers and/or I/O devices may be connected with the I/O bus 926, such as I/O controller 928 and I/O device 930, as illustrated.

I/O device 930 may also include an input device (not shown), such as an alphanumeric input device, including alphanumeric and other keys for communicating information and/or command selections to the processors 902-906. Another type of user input device includes cursor control, such as a mouse, a trackball, or cursor direction keys for communicating direction information and command selections to the processors 902-906 and for controlling cursor movement on the display device.

System 900 may include sensors 940 (e.g., sensors for the furnace 100 of FIG. 1), such as temperature sensors, pressure sensors, flow sensors, and the like, used to provide data to the furnace catalyst bed devices 909, where the information may be extracted, averaged, and used to estimate catalyst bed life (e.g., according to FIG. 8).

System 900 may include a dynamic storage device, referred to as main memory 916, or a random-access memory (RAM) or other computer-readable devices coupled to the processor bus 912 for storing information and instructions to be executed by the processors 902-906. Main memory 916 also may be used for storing temporary variables or other intermediate information during execution of instructions by the processors 902-906. System 900 may include a read only memory (ROM) and/or other static storage device coupled to the processor bus 912 for storing static information and instructions for the processors 902-906. The system outlined in FIG. 9 is but one possible example of a computer system that may employ or be configured in accordance with aspects of the present disclosure.

According to one embodiment, the above techniques may be performed by computer system 900 in response to processor 904 executing one or more sequences of one or more instructions contained in main memory 916. These instructions may be read into main memory 916 from another machine-readable medium, such as a storage device. Execution of the sequences of instructions contained in main memory 916 may cause processors 902-906 to perform the process steps described herein. In alternative embodiments, circuitry may be used in place of or in combination with the software instructions. Thus, embodiments of the present disclosure may include both hardware and software components.

A machine-readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, solid-state drives (SSDs), and the like. The one or more memory devices 906 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 916, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present disclosure. For example, while the embodiments described above refer to particular features, the scope of this technology also includes embodiments having different combinations of features and embodiments that do not include all of the described features. Accordingly, the scope of the present disclosure is intended to embrace all such alternatives, modifications, and variations together with all equivalents thereof.

What is claimed:

1. A method for estimating the end-of-life of a furnace catalyst bed, the method comprising:
extracting first measurements of a furnace catalyst bed;
determining time-period averages of the extracted first measurements of the furnace catalyst bed over multiple time periods;
determining a catalyst activity indicative of an efficiency of a selective reduction catalyst in reducing NOx concentrations for the furnace catalyst bed at a first time;
generating a first linear regression of the catalyst activity based on averages of the multiple time periods; and
generating a health score of the furnace catalyst bed at a second time based on the first linear regression, the health score indicative of an estimated end-of-life of the furnace catalyst bed.

2. The method of claim 1, further comprising:
inputting to a machine learning model comprising the first linear regression a cleaned feature indicating that the furnace catalyst bed has been cleaned;
training the machine learning model using the label to determine a coefficient of the cleaned feature, wherein the coefficient is indicative of increased relative catalyst activity based on the furnace catalyst bed having been cleaned; and
determining the estimated end-of-life of the furnace, after having been cleaned, based on the coefficient,
wherein the health score of the furnace catalyst bed is based on the furnace catalyst bed having been cleaned.

3. The method of claim 1, wherein the time periods are about 0.1 days, 0.2 days, 0.5 days, 1 day, 2 days, 5 days, or 10 days.

4. The method of claim 1, wherein the first measurements comprise an NOx concentration upstream of the furnace catalyst bed, an NOx concentration after the furnace catalyst bed at a furnace stack, an NH₃ feed rate to the furnace catalyst bed, an NH₃ concentration after the furnace catalyst bed at the furnace stack, a furnace catalyst bed temperature, a furnace catalyst bed inlet temperature, a furnace catalyst bed inlet O₂ concentration, an O₂ concentration after the furnace catalyst bed at the furnace stack, a firing rate of fuel gas burners in the furnace, a specific gravity of fuel gas to the furnace burners, a time of operation of the furnace catalyst bed, or any combinations thereof.

5. The method of claim 1, wherein the first linear regression is based on a relative catalyst activity of a first-order reaction of NO, 4NO+4NH₃+O₂→4N₂+6H₂O, associated with the furnace catalyst bed and a zero-order reaction of ammonia associated with the furnace catalyst bed compared to the catalyst activity.

6. The method of claim 1, wherein the catalyst activity is based on a flue gas flow rate associated with the furnace catalyst bed, a total catalyst surface area, and a NOx reduction when a NH₃ concentration at an inlet of the furnace catalyst bed divided by a change in a NOx concentration at the inlet is greater than 1.

7. The method of claim 6, wherein: the change in NOx concentration after the furnace catalyst bed is determined based on one minus a ratio of NOx output over NOx input associated with the furnace catalyst bed.

8. The method of claim 1, further comprising:
extracting second measurements of the furnace catalyst bed;
determining second time period averages of the extracted second measurements of the furnace catalyst bed during a time period of multiple days; and
generating a second linear regression of the catalyst activity based on the time period averages,
wherein the health score is further based on the second linear regression.

9. The method of claim 1, further comprising:
identifying an intersection between the first linear regression and a critical health score threshold,
wherein the intersection is indicative of the estimated end-of-life of the furnace catalyst bed.

10. The method of claim 1, wherein the first linear regression is based on an equation in which ten multiplied by the natural log of a sum of one and a ratio of the catalyst activity equals ten multiplied by a difference between one and a ratio of time over the health score.

11. A device for estimating the end-of-life of a furnace catalyst bed, the device comprising memory coupled to at least one processor, the at least one processor configured to:
extract first measurements of a furnace catalyst bed;
determine time period averages of the extracted first measurements of the furnace catalyst bed over multiple time periods;
determine a catalyst activity indicative of an efficiency of a selective reduction catalyst in reducing NOx concentrations for the furnace catalyst bed at a first time;
generate a first linear regression of the catalyst activity based on the time period averages; and
generate a health score of the furnace catalyst bed at a second time based on the first linear regression, the health score indicative of an estimated end-of-life of the furnace catalyst bed.

12. The device of claim 11, wherein the multiple time periods are about 0.1 days, 0.2 days, 0.5 days, 1 day, 2 days, 5 days, or 10 days.

13. The device of claim 11, wherein the first measurements comprise an NOx concentration upstream of the furnace catalyst bed, an NOx concentration after the furnace catalyst bed at a furnace stack, an NH₃ feed rate to the furnace catalyst bed, an NH₃ concentration after the furnace catalyst bed at the furnace stack, a furnace catalyst bed temperature, a furnace catalyst bed inlet temperature, a furnace catalyst bed inlet O₂ concentration, an O₂ concentration after the furnace catalyst bed at the furnace stack, a firing rate of fuel gas burners in the furnace, a specific gravity of fuel gas to the furnace burners, a time of operation of the furnace catalyst bed, or any combinations thereof.

14. The device of claim 11, wherein the first linear regression is based on a relative catalyst activity of a first-order reaction of NO, 4NO+4NH₃+O₂→4N₂+6H₂O, associated with the furnace catalyst bed and a zero-order reaction of ammonia associated with the furnace catalyst bed compared to the catalyst activity.

15. The device of claim 11, wherein the catalyst activity is based on a flue gas flow rate associated with the furnace catalyst bed, a total catalyst surface area, and a NOx reduction when a NH₃ concentration at an inlet of the furnace catalyst bed divided by a change in a NOx concentration at the inlet is greater than 1.

16. The device of claim 15, wherein: the change in NOx concentration after the furnace catalyst bed based on one minus a ratio of NOx output over NOx input associated with the furnace catalyst bed.

17. The device of claim 11, wherein the at least one processor is further configured to:
extract second measurements of the furnace catalyst bed;
determine second time period averages of the extracted second measurements of the furnace catalyst bed during a time period of multiple days; and
generate a second linear regression of the catalyst activity based on the second time period averages,
wherein the health score is further based on the second linear regression.

18. The device of claim 11, wherein the at least one processor is further configured to:
identify an intersection between the first linear regression and a critical health score threshold, wherein the intersection is indicative of the estimated end-of-life of the furnace catalyst bed.

19. A system for estimating the end-of-life of a furnace catalyst bed, the system comprising:
a furnace comprising a furnace catalyst bed associated with reacting NOx from the furnace and NH₃ from an ammonia vaporizer into N₂ and H₂O; and
memory coupled to at least one processor, the at least one processor configured to:
extract first measurements of the furnace catalyst bed;
determine time period averages of the extracted first measurements of the furnace catalyst bed during multiple time periods;
determine a catalyst activity indicative of an efficiency of a selective reduction catalyst in reducing NOx concentrations for the furnace catalyst bed at a first time;
generate a first linear regression of the catalyst activity based on the time period averages; and
generate a health score of the furnace catalyst bed at a second time based on the first linear regression, the health score indicative of an estimated end-of-life of the furnace catalyst bed.

20. The system of claim 19, wherein the first measurements comprise an NOx concentration within a furnace, an NOx concentration upstream of the furnace catalyst bed, an NOx concentration after the furnace catalyst bed at a furnace stack, an NH₃ feed rate to the furnace catalyst bed, an NH₃ concentration after the furnace catalyst bed at the furnace stack, a furnace catalyst bed temperature, a furnace catalyst bed inlet temperature, a furnace catalyst bed inlet O₂ concentration, an O₂ concentration after the furnace catalyst bed at the furnace stack, a firing rate of fuel gas burners in the furnace, a specific gravity of fuel gas to the furnace burners, a time of operation of the furnace catalyst bed, or any combinations thereof.
